(19) United States
(12) Patent Application Publication
(10) Pub. No.: US 2026/0330059 A1
(43) Pub. Date: Oct. 22, 2026

(54) SECURING SENSOR DATA

(71) Applicant: Snap Inc., Santa Monica, CA (US)

(72) Inventors: Ilteris Canberk, Los Angeles, CA (US); Terek Judi, Venice, CA (US); Baranidharan Muthukumaran, San Diego, CA (US); Fedir Poliakov, Playa Vista, CA (US); Dhritiman Sagar, New York, NY (US); Daniel Wagner, Vienna (AT)

(21) Appl. No.: 19/648,331

(22) Filed: Apr. 15, 2026

Related U.S. Application Data
(60) Provisional application No. 63/791,183, filed on Apr. 18, 2025.

(51) Int. Cl. G06F 21/62

(52) U.S. Cl. CPC G06F 21/6245

(57) ABSTRACT

The subject technology provides for securing sensor data. Sensor data and an execution pipeline can be obtained by a secure processing environment that invokes the execution pipeline on the sensor data to produce an output. The output can be matched against a set of acceptable outputs to determine whether the output from the execution pipeline is acceptable. If not, the output can be discarded or otherwise secured in the secure execution environment. If the output is acceptable, the output can be communicated to an external processing environment for use, for example, by an external application.

### CLAIM OF PRIORITY

This patent application claims the benefit of priority, under 35 U.S.C. § 119, to United States Provisional Application Serial No. 63/791,183, titled “SECURE PROCESSING OF PERSONAL DATA ON AUGMENTED REALITY GLASSES” and filed on Apr. 18, 2025, the entirety of which is hereby incorporated by reference herein.

### TECHNICAL FIELD

The present disclosure relates generally to processing user-generated content, and more specifically to securing sensor data.

### BACKGROUND

Augmented reality (AR) is a computing framework in which digital information is registered or composited with a physical environment to produce a combined perceptual environment. A typical AR system includes a sensing subsystem, a spatial tracking subsystem, a rendering subsystem, or a display subsystem. The sensing subsystem can collect environmental information through sensors such as cameras, inertial measurement units (IMUs), depth sensors, or global navigation satellite system (GNSS) receivers. The spatial tracking subsystem can process sensor observations to estimate device pose relative to a physical environment through techniques such as simultaneous localization or mapping (SLAM). The rendering subsystem can generate virtual objects or annotations that correspond to the estimated pose or scene geometry. The display subsystem can present the rendered content through optical see-through displays, video see-through displays, or handheld displays such as smartphones or tablets.

AR systems generally use geometric registration between digital content or physical scene structure in order to maintain spatial consistency during user movement or environmental change. Registration can involve camera calibration, feature detection, feature matching, or coordinate transformation between device coordinate frames or world coordinate frames. Computer vision techniques can be used to detect planar surfaces, object boundaries, or semantic scene elements in order to anchor digital objects to physical locations. Real-time rendering pipelines can update virtual content in response to pose updates with low latency in order to maintain perceptual stability. Hardware acceleration through graphics processing units (GPUs) or dedicated vision processors can help to support real-time processing constraints.

### BRIEF DESCRIPTION OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates an example of a networked environment in which the present disclosure can be deployed, according to an embodiment.

FIG. 2 illustrates an example of a messaging system that has both client-side and server-side functionality, according to an embodiment.

FIG. 3 illustrates an example of a data structure as maintained in a database, according to an embodiment.

FIG. 4 illustrates an example of a message, according to an embodiment.

FIG. 5 illustrates an example of a system including a head-wearable apparatus, according to an embodiment.

FIG. 6 illustrates an example of an environment including a system for securing sensor data, according to an embodiment.

FIG. 7 illustrates an example of a system architecture for securing sensor data, according to an embodiment.

FIG. 8 illustrates an example of a secure processing pipeline, according to an embodiment.

FIG. 9 is a flow diagram of an example of a method for securing sensor data, according to an embodiment.

FIG. 10 is a flow diagram of an example of a method for securing sensor data, according to an embodiment.

FIG. 11 illustrates an example of a machine in the form of a computer system within which a set of instructions can be executed to cause the machine to perform any one or more of the methodologies described herein, according to an embodiment.

FIG. 12 illustrates an example of a software architecture within which examples can be implemented, according to an embodiment.

### DETAILED DESCRIPTION

Augmented reality technology aims to bridge a gap between virtual environments and a real-world environment by providing an enhanced real-world environment that is augmented with electronic information. As a result, electronic information appears to be part of the real-world environment as perceived by a user. In an example, augmented reality technology further provides a user interface to interact with the electronic information that is overlaid in the enhanced real-world environment.

AR technology has rapidly evolved to provide increasingly immersive and interactive experiences. Camera data, which enables AR applications to perceive and interact with the user’s environment, often forms a core component in AR operation. However, raw camera data (e.g., images or image frames) can be sensitive to the user or other people captured by the camera. Outside of core AR processing, the availability of camera image data enables additional user functionality. For example, users with a range of interests from various locations can capture digital images of various subjects and make captured images available to others via networks, such as the Internet. To enhance users' experiences with digital images or to provide various features, enabling computing devices to perform image processing operations on various objects or features captured in a wide range of changing conditions (e.g., changes in image scales, noises, lighting, movement, or geometric distortion) can be challenging and computationally intensive. For often resource-constrained wearable AR devices, such processing is often better handled by an external (e.g., network-accessible), edge, cloud, or other service.

Conventional permission-based security approaches typically grant developers (e.g., entities provided software or tools to enable additional functionality for a user of a wearable device) full control over sensitive data pathways, such as camera feeds, database schemas, cloud functions, or other data with minimal restrictions on how user data is accessed or stored. This approach can raise issues for sensitive data captured by the wearable device (e.g., camera data, positioning data, etc.), as it could potentially expose users' private environments or activities to third parties without appropriate safeguards. Current approaches to securing user data in network (e.g., cloud) environments often rely on simple authentication mechanisms that do not account for the unique privacy concerns associated with wearable sensor data.

To address the security concerns of sensitive data captured by sensors of a wearable device, such as an AR device, including the challenge of enabling useful third-party AR applications that seek to use camera access (e.g., during object detection or pose estimation) while preventing those applications from being able to leak or misuse the raw camera data, an execution pipeline can be delivered to a secure environment to interact with the sensitive data to produce usable output. This output can then be tested against acceptance criteria to ensure that no sensitive data leaves the secure processing environment before it is used by the external entity (e.g., an external processing environment). This arrangement goes beyond simple permission controls to architecturally restrict what data developers can access while enabling compelling AR experiences.

The system and techniques described herein implement as a split-environment architecture that provides robust technical protections by physically separating sensitive data processing from general application code. This enables developers to create execution pipelines to perform desired operations on camera, or other sensor data (e.g., location, audio, etc.) invoked in a secure processing environment while preventing any ability to store, transmit, or leak the raw sensitive data. In an example, the secure processing environment verifies that output of the execution pipeline is acceptable (e.g., meets acceptance criteria) via an output checker configured to enforce controls over what data, or in what format the data, is permitted to exit the secure processing environment. By restricting outputs to compact formats, such as single integers or small floating-point arrays, the architecture reduces (e.g., to impossibility) the ability to reconstruct or leak sensitive sensor data, while still enabling useful functionality like object detection or pose estimation.

The various elements and techniques described herein provide advantages, such as for AR wearable devices (e.g., glasses, watches, etc.) over other devices (e.g., mobile phones), because of the intimate nature of wearable devices. For example, head-mounted cameras in AR glasses can involve greater privacy implications due to their continuous recording capability and perspective capturing the user's field of view. The systems and techniques described herein provide technological safeguards against privacy breaches that go beyond traditional data protections (e.g., granting permission to use a camera), ensuring that private user data is protected at an architectural level while enabling developers to create compelling AR applications.

The approach described herein enables flexibility for developers through a multi-stage pipeline, facilitating custom pre-processing, machine learning models, or post-processing while maintaining strict security boundaries. This enables innovation in AR applications without compromising the core privacy protections built into the architecture. Thus, examples described herein enable generating AR content (e.g., images, video, and the like) using a generative machine learning (ML) (e.g., an artificial intelligence (AI)) pipeline that receives, as inputs, media content representing a head of an individual (e.g., a self photograph or “selfie” image), a text condition (e.g., textual information or textual description), and a pose template, to provide output media content based on the aforementioned inputs while maintaining user privacy or security. Additional details and examples are provided below.

Messaging systems are frequently utilized and are increasingly leveraged by users of mobile computing devices, in various settings, to provide different types of functionality in a convenient manner. As described herein, the subject messaging system can include practical applications that provide improvements in capturing image data and rendering AR content (e.g., images, videos, and the like) based on the captured image data by at least providing technical improvements with capturing image data using power and resource-constrained electronic devices. Such improvements in capturing image data are enabled by techniques provided by the subject technology, which reduce latency and increase efficiency in processing captured image data, thereby also reducing power consumption in the capturing devices.

As described herein, the systems and techniques support the creation and sharing of interactive media, referred to herein as messages including 3D content or AR effects, throughout various components of a messaging system. In an example, messages can enter the system from a live camera or via storage (e.g., where messages including 3D content or AR effects are stored in memory or a database). In an example, motion sensor input, and loading of external effects or asset data can be supported.

As referred to herein, the phrase “augmented reality experience,” “augmented reality content item,” “augmented reality content generator” includes or refers to various image processing operations corresponding to an image modification, filter, AR content generators, media overlay, transformation, and the like, and additionally can include playback of audio or music content during presentation of AR content or media content, as described further herein.

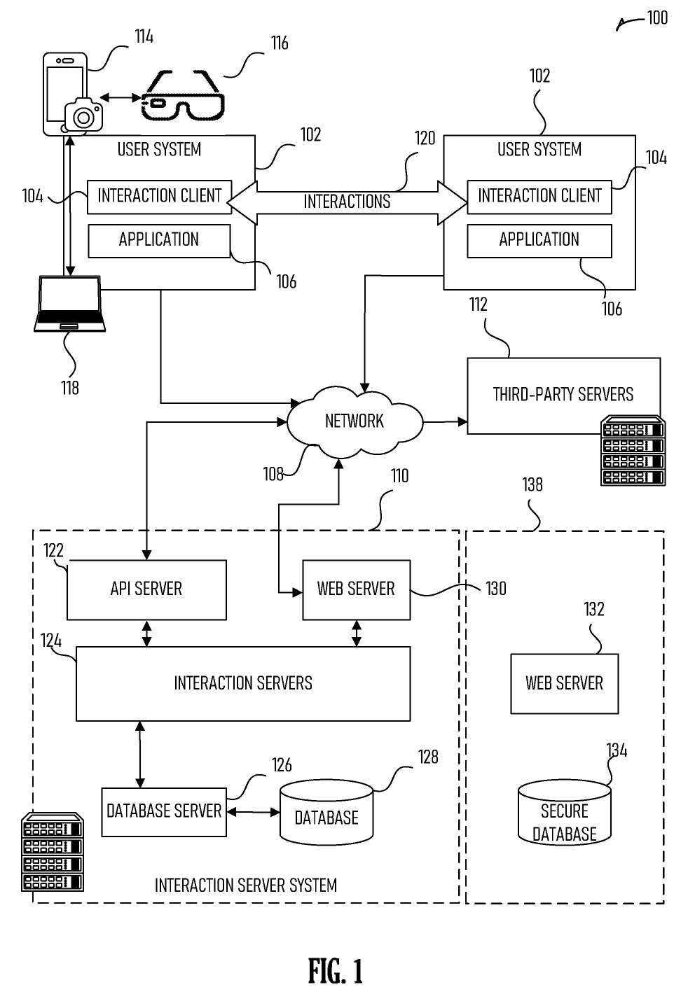

The following material related to FIGS. 1–5 describes devices, systems, or techniques to support AR apparatus operation, including an example of a networking computing environment, an example of a system architecture, an example of a data architecture, an example of a data communications architecture, and an example of a system with a head-wearable apparatus. These elements provide differing elements of embodiments to support the system for securing wearable camera data described below.

### NETWORKED COMPUTING ENVIRONMENT

FIG. 1 illustrates an example of a networked environment in which the present disclosure can be deployed, according to an embodiment. Specifically, an example interaction system 100 for facilitating interactions (e.g., exchanging text messages, conducting text, audio, and video calls, or playing games) over a network is shown. The interaction system 100 includes multiple user systems 102, each of which hosts multiple applications, including an interaction client 104 and other applications 106. Each interaction client 104 is communicatively coupled, via one or more communication networks, including a network 108 (e.g., the Internet), to other instances of the interaction client 104 (e.g., hosted on respective other user systems 102), an interaction server system 110, and third-party servers 112. An interaction client 104 can also communicate with locally hosted applications 106 using Application Programming Interfaces (APIs).

Each user system 102 can include multiple user devices, such as a mobile device 114, a head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 include functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality, either within the interaction client 104 or the interaction server system 110, can be a design choice. For example, it can be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data can include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106, and the third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

As also illustrated, interaction servers 124 are communicatively coupled to a backend as a service platform 138, which facilitates access to a secure database server 132. Secure database server 132 stores data in a secure manner (e.g., access-controlled, and the like) in secure database 134, as discussed further herein. The backend as a service platform 138 implements a backend as a service, which can be understood as a cloud computing model that provides developers with pre-built backend functionalities, eliminating the need to manage the underlying infrastructure, and offers a suite of ready-to-use services and features that developers can integrate into their applications through APIs and SDKs.

The Application Program Interface (API) server 122 receives and transmits interaction data (e.g., commands and message payloads) between the interaction servers 124 and the user systems 102 (and, for example, interaction clients 104 and other applications 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the setting of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

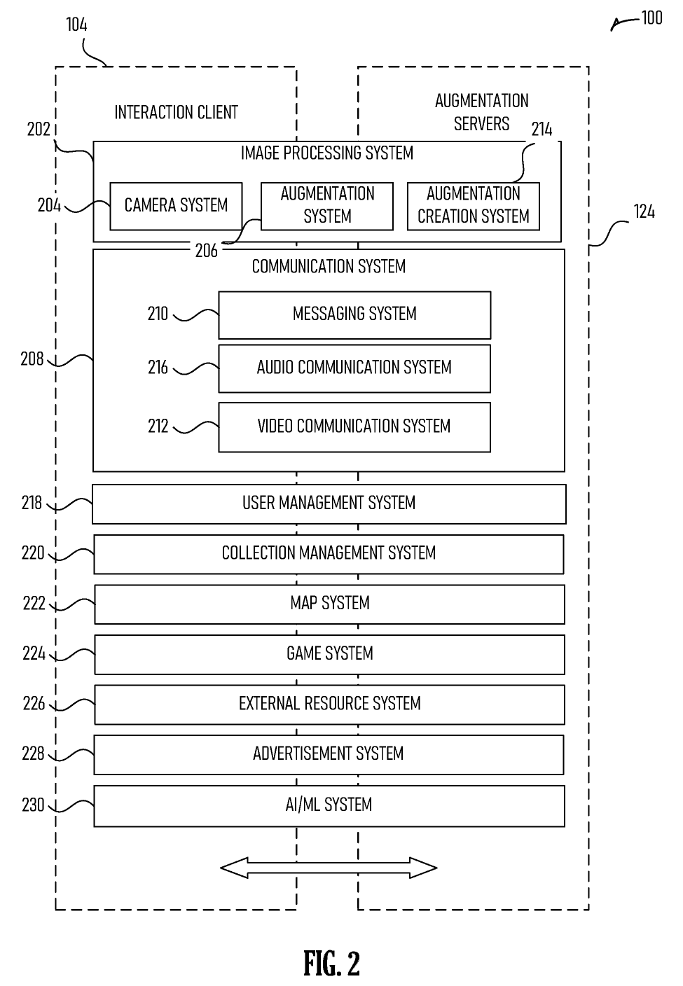

The interaction servers 124 host multiple systems and subsystems, described below with reference to FIG. 2.

### SYSTEM ARCHITECTURE

FIG. 2 illustrates an example of a messaging system that has both client-side and server-side functionality, according to an embodiment. The provided block diagram illustrates further details regarding the interaction system 100, according to an embodiment. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) can have components that enable it to operate independently and communicate with other services. Example components of a microservice subsystem can include:
Function logic: The function logic implements the functionality of the microservice subsystem, representing a specific capability or function that the microservice provides.
API interface: Microservices can communicate with each other's components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem can be responsible for its own data storage, which can be in the form of a database, cache, or other storage mechanism (e.g., using the database server 126 and database 128). This enables a microservice subsystem to operate independently of other microservices of the interaction system 100.
Service discovery: Microservice subsystems can find and communicate with other microservice subsystems of the interaction system 100. Service discovery mechanisms enable microservice subsystems to locate and communicate with other microservice subsystems in a scalable and efficient way.
Monitoring and logging: Microservice subsystems can need to be monitored and logged in order to ensure availability and performance. Monitoring and logging mechanisms enable the tracking of the health and performance of a microservice subsystem.

In some examples, the interaction system 100 can employ a monolithic architecture, a service-oriented architecture (SOA), a function-as-a-service (FaaS) architecture, or a modular architecture:

### Example subsystems are discussed below

An image processing system 202 provides various functions that enable a user to capture and augment (e.g., annotate or otherwise modify or edit) media content associated with a message.

A camera system 204 includes control software (e.g., in a camera application) that interacts with and controls the camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 502 of a user system 102. These augmentations are selected by the augmentation system 206 and presented to a user of an interaction client 104, based on a number of inputs and data, such as, for example:
Geolocation of the user system 102; and
Entity relationship information of the user of the user system 102.

An augmentation can include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at the user system 102 for communication in a message, or applied to video content, such as a video content stream or feed transmitted from an interaction client 104. As such, the image processing system 202 can interact with, and support, the various subsystems of the communication system 208, such as the messaging system 210 and the video communication system 212.

A media overlay can include text or image data that can be overlaid on top of a photograph taken by the user system 102 or a video stream produced by the user system 102. In some examples, the media overlay can be a location overlay (e.g., Venice Beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay can include other indicia associated with the merchant. The media overlays can be stored in the databases 128 and accessed through the database server 126.

The image processing system 202 provides a user-based publication platform that enables users to select a geolocation on a map and upload content associated with the selected geolocation. The user can also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators, including, for example, custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310, and profile data 302) regarding users and relationships between users of the interaction system 100.

A collection management system 220 is operationally responsible for managing sets or collections of media (e.g., collections of text, image, video, and audio data). A collection of content (e.g., messages, including images, video, text, and audio) can be organized into an “event gallery” or an “event story.” Such a collection can be made available for a specified time period, such as the duration of an event to which the content relates. For example, content relating to a music concert can be made available as a “story” for the duration of that music concert. The collection management system 220 can also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In an example, compensation can be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location can be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 can launch a web-based resource (e.g., application) by accessing the HTML5 file from the third-party servers 112 associated with the web-based resource. Applications hosted by third-party servers 112 are programmed in JavaScript, leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 can be used by the augmentation system 206 to generate augmented content and augmented reality experiences, such as adding virtual objects or animations to real-world images. The communication system 208 and messaging system 210 can use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 can also provide chatbot functionality to message interactions 120 between user systems 102 and between a user system 102 and the interaction server system 110. The artificial intelligence and machine learning system 230 can also work with the audio communication system 216 to provide speech recognition and natural language processing capabilities, allowing users to interact with the interaction system 100 using voice commands.

### DATA ARCHITECTURE

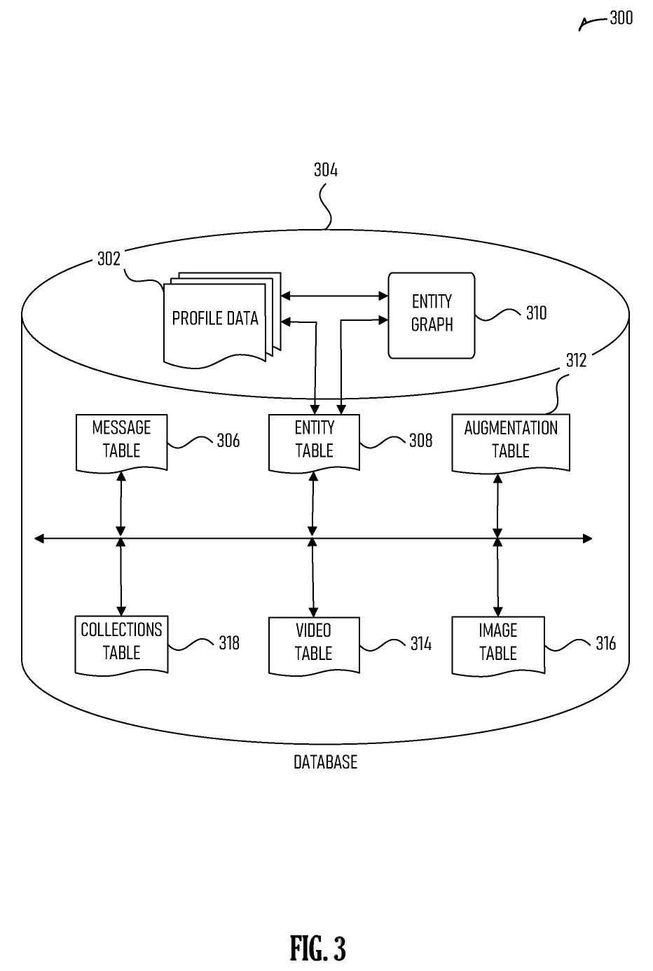

FIG. 3 illustrates an example of a data structure (e.g., data structures 300) as maintained in a database 304, according to an embodiment. The schematic diagram illustrates data structures 300, which can be stored in the database 304 of the interaction server system 110, according to an example. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that can be included in a message, and included within the message data stored in the message table 306, are described below.

An entity table 308 stores entity data, and is linked (e.g., referentially) to an entity graph 310 and profile data 302. Entities for which records are maintained within the entity table 308 can include individuals, corporate entities, organizations, objects, places, events, and so forth. Regardless of entity type, any entity regarding which the interaction server system 110 stores data can be a recognized entity. Each entity is provided with a unique identifier, as well as an entity type identifier (not shown).

The entity graph 310 stores information regarding relationships and associations between entities. Such relationships can be social, professional (e.g., working at a common corporation or organization), interest-based, or activity-based, merely for example. Certain relationships between entities can be unidirectional, such as a subscription by an individual user to digital content of a commercial or publishing user (e.g., a newspaper or other digital media outlet, or a brand). Other relationships can be bidirectional, such as a “friend” relationship between individual users of the interaction system 100.

Certain permissions and relationships can be attached to each relationship, and also to each direction of a relationship. For example, a bidirectional relationship (e.g., a friend relationship between individual users) can include authorization for the publication of digital content items between the individual users, but can impose certain restrictions or filters on the publication of such digital content items (e.g., based on content characteristics, location data, or time of day data). Similarly, a subscription relationship between an individual user and a commercial user can impose different degrees of restrictions on the publication of digital content from the commercial user to the individual user, and can significantly restrict or block the publication of digital content from the individual user to the commercial user. A particular user, as an example of an entity, can record certain restrictions (e.g., by way of privacy settings) in a record for that entity within the entity table 308. Such privacy settings can be applied to all types of relationships within the context of the interaction system 100, or can be selectively applied to certain types of relationships.

The profile data 302 stores multiple types of profile data about a particular entity. The profile data 302 can be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user can then selectively include one or more of these avatar representations within the content of messages communicated via the interaction system 100, and on map interfaces displayed by interaction clients 104 to other users. The collection of avatar representations can include “status avatars,” which present a graphical representation of a status or activity that the user can select to communicate at a particular time.

Where the entity is a group, the profile data 302 for the group can similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters can be of various types, including user-selected filters from a set of filters presented to a sending user by the interaction client 104 when the sending user is composing a message. Other types of filters include geolocation filters (also known as geo-filters), which can be presented to a sending user based on geographic location. For example, geolocation filters specific to a neighborhood or special location can be presented within a user interface by the interaction client 104, based on geolocation information determined by a Global Positioning System (GPS) unit of the user system 102.

Another type of filter is a data filter, which can be selectively presented to a sending user by the interaction client 104 based on other inputs or information gathered by the user system 102 during the message creation process. Examples of data filters include the current temperature at a specific location, the current speed at which a sending user is traveling, battery life for a user system 102, or the current time.

Other augmentation data that can be stored within the image table 316 includes augmented reality content items (e.g., corresponding to applying “lenses” or augmented reality experiences). An augmented reality content item can be a real-time special effect and sound that can be added to an image or a video.

A collections table 318 stores data regarding collections of messages and associated image, video, or audio data, which are compiled into a collection (e.g., a story or a gallery). The creation of a particular collection can be initiated by a particular user (e.g., each user for which a record is maintained in the entity table 308). A user can create a “personal story” in the form of a collection of content that has been created and sent/broadcast by that user. To this end, the user interface of the interaction client 104 can include an icon that is user-selectable to enable a sending user to add specific content to his or her personal story.

A collection can also constitute a “live story,” which is a collection of content from multiple users that is created manually, automatically, or using a combination of manual and automatic techniques. For example, a “live story” can constitute a curated stream of user-submitted content from various locations and events. Users whose client devices have location services enabled and are at a common location event at a particular time can, for example, be presented with an option, via a user interface of the interaction client 104, to contribute content to a particular live story. The live story can be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story can employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 can associate various augmentations from the augmentation table 312 with various images and videos stored in the image table 316 and the video table 314.

In an example, data structures 300 can be stored in database 128 or secure database 134.

### DATA COMMUNICATIONS ARCHITECTURE

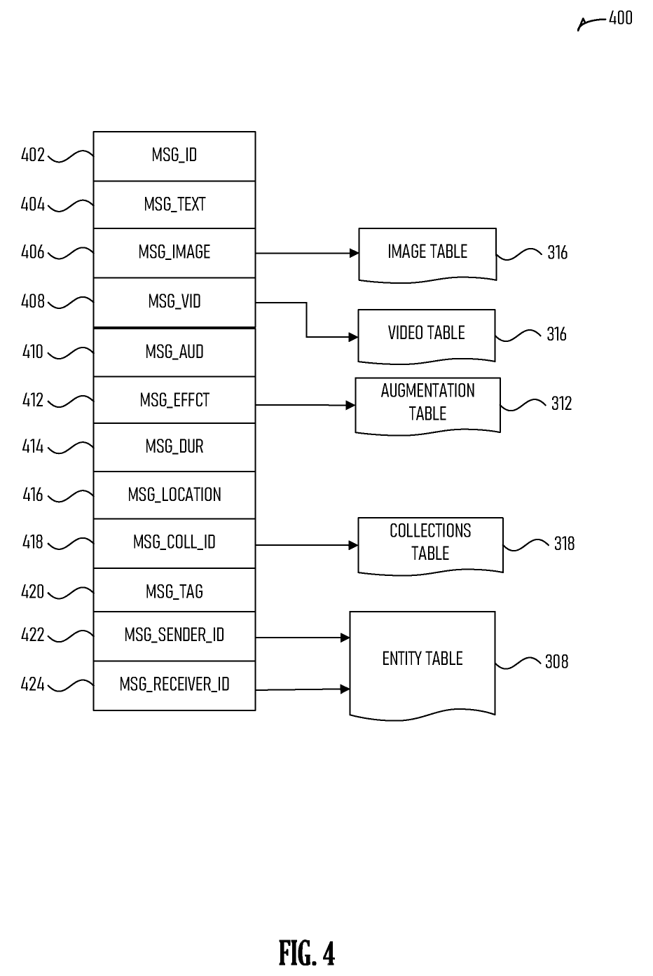

FIG. 4 illustrates an example of a message 400, according to an embodiment. In an example, the illustrated structure of the message 400 can be generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier (MSG_ID) 402: a unique identifier that identifies the message 400.
Message geolocation parameter (MSG_LOCATION) 416: geolocation data (e.g., latitudinal and longitudinal coordinates) associated with the content payload of the message. Multiple message geolocation parameter 416 values can be included in the payload, each of these parameter values being associated with respect to content items included in the content (e.g., a specific image within the message image payload 406, or a specific video in the message video payload 408).
Message story identifier (MSG_COLL_ID) 418: identifier values identifying one or more content collections (e.g., “stories” identified in the collections table 318) with which a particular content item in the message image payload 406 of the message 400 is associated. For example, multiple images within the message image payload 406 can each be associated with multiple content collections using identifier values.
Message tag (MSG_TAG) 420: each message 400 can be tagged with multiple tags, each of which is indicative of the subject matter of content included in the message payload. For example, where a particular image included in the message image payload 406 depicts an animal (e.g., a lion), a tag value can be included within the message tag 420 that is indicative of the relevant animal. Tag values can be generated manually, based on user input, or can be automatically generated using, for example, image recognition.
Message sender identifier (MSG_SENDER_ID) 422: an identifier (e.g., a messaging system identifier, email address, or device identifier) indicative of a user of the user system 102 on which the message 400 was generated and from which the message 400 was sent.
Message receiver identifier (MSG_RECEIVER_ID) 424: an identifier (e.g., a messaging system identifier, email address, or device identifier) indicative of a user of the user system 102 to which the message 400 is addressed.
Message text payload (MSG_TEXT) 404: text, to be generated by a user via a user interface of the user system 102, and that is included in the message 400.
Message image payload (MSG_IMAGE) 406: image data, captured by a camera component of a user system 102 or retrieved from a memory component of a user system 102, and that is included in the message 400. Image data for a sent or received message 400 can be stored in the image table 316.
Message video payload (MSG_VID) 408: video data, captured by a camera component or retrieved from a memory component of the user system 102, and that is included in the message 400. Video data for a sent or received message 400 can be stored in the video table 314.
Message audio payload (MSG_AUD) 410: audio data, captured by a microphone or retrieved from a memory component of the user system 102, and that is included in the message 400.
Message augmentation data (MSG_EFFCT) 412: augmentation data (e.g., filters, stickers, or other annotations or enhancements) that represents augmentations to be applied to message image payload 406, message video payload 408, or message audio payload 410 of the message 400. Augmentation data for a sent or received message 400 can be stored in the augmentation table 312.
Message duration parameter (MSG_DUR) 414: parameter value indicating, in seconds, the amount of time for which content of the message (e.g., the message image payload 406, message video payload 408, message audio payload 410) is to be presented or made accessible to a user via the interaction client 104.

The contents (e.g., values) of the various components of message 400 can be pointers to locations in tables within which content data values are stored. For example, an image value in the message image payload 406 can be a pointer to (or address of) a location within an image table 316. Similarly, values within the message video payload 408 can point to data stored within an image table 316, values stored within the message augmentation data 412 can point to data stored in an augmentation table 312, values stored within the message story identifier 418 can point to data stored in a collections table 318, and values stored within the message sender identifier 422 and the message receiver identifier 424 can point to user records stored within an entity table 308.

### SYSTEM WITH HEAD-WEARABLE APPARATUS

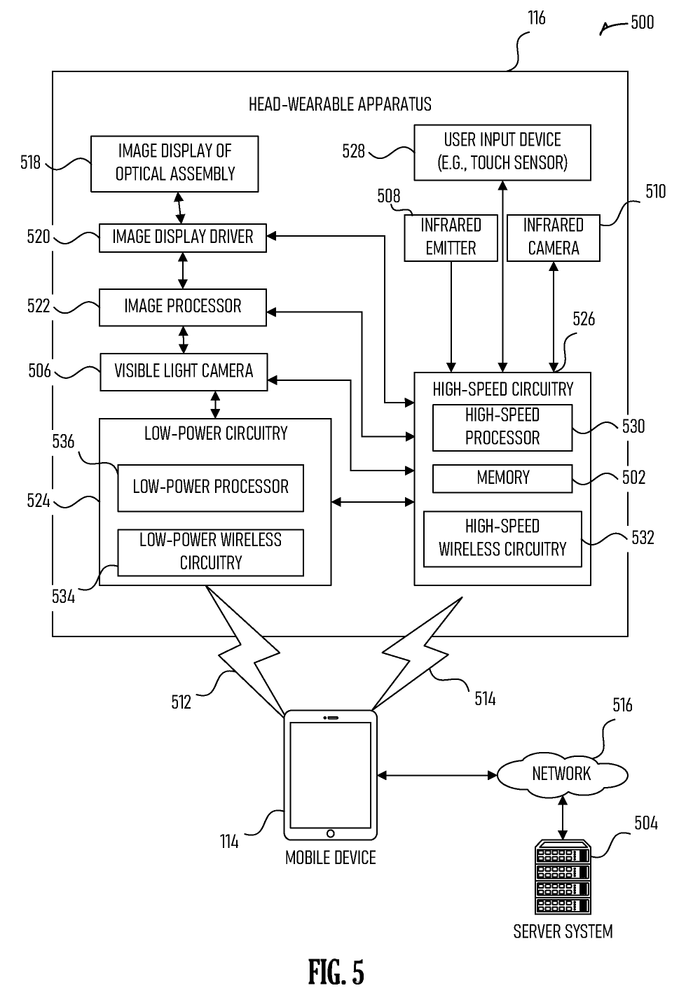

FIG. 5 illustrates an example of a system 500 including a head-wearable apparatus 116, according to an embodiment. As illustrated, the head-wearable apparatus 116 is communicatively coupled to a mobile device 114 and various server systems 504 (e.g., the interaction server system 110) via various networks 108.

The head-wearable apparatus 116 includes one or more cameras, each of which can be, for example, a visible light camera 506, an infrared emitter 508, and an infrared camera 510.

The mobile device 114 connects with the head-wearable apparatus 116 using both a low-power wireless connection 512 and a high-speed wireless connection 514. The mobile device 114 is also connected to the server system 504 and the network 516.

The head-wearable apparatus 116 further includes two image displays of the image display of optical assembly 518. The two image displays of optical assembly 518 include one associated with the left lateral side and one associated with the right lateral side of the head-wearable apparatus 116. The head-wearable apparatus 116 also includes an image display driver 520, an image processor 522, low-power circuitry 524, and high-speed circuitry 526. The image display of optical assembly 518 is for presenting images and videos, including an image that can include a graphical user interface to a user of the head-wearable apparatus 116.

The image display driver 520 commands and controls the image display of optical assembly 518. The image display driver 520 can deliver image data directly to the image display of optical assembly 518 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Graphics (PNG), Joint Photographic Experts Group (JPEG), Tagged Image File Format (TIFF), or Exchangeable Image File Format (EXIF) or the like.

The head-wearable apparatus 116 includes a frame and stems (or temples) extending from a lateral side of the frame. The head-wearable apparatus 116 further includes a user input device 528 (e.g., touch sensor or push button), including an input surface on the head-wearable apparatus 116. The user input device 528 (e.g., touch sensor or push button) is to receive from the user an input selection to manipulate the graphical user interface of the presented image.

The components shown in FIG. 5 for the head-wearable apparatus 116 are located on one or more circuit boards, for example, a PCB or flexible PCB, in the rims or temples. Alternatively, or additionally, the depicted components can be located in the chunks, frames, hinges, or bridge of the head-wearable apparatus 116. Left and right visible light cameras 506 can include digital camera elements such as a complementary metal oxide–semiconductor (CMOS) image sensor, charge-coupled device, camera lenses, or any other respective visible or light-capturing elements that can be used to capture data, including images of scenes with unknown objects.

The head-wearable apparatus 116 includes a memory 502, which stores instructions to perform a subset or all of the functions described herein. The memory 502 can also include a storage device.

As shown in FIG. 5, the high-speed circuitry 526 includes a high-speed processor 530, a memory 502, and high-speed wireless circuitry 532. In some examples, the image display driver 520 is coupled to the high-speed circuitry 526 and operated by the high-speed processor 530 in order to drive the left and right image displays of the image display of optical assembly 518. The high-speed processor 530 can be any processor capable of managing high-speed communications and operation of any general computing system needed for the head-wearable apparatus 116. The high-speed processor 530 includes processing resources needed for managing high-speed data transfers on a high-speed wireless connection 514 to a wireless local area network (WLAN) using the high-speed wireless circuitry 532. In an example, the high-speed processor 530 executes an operating system, such as a LINUX operating system or other such operating system of the head-wearable apparatus 116, and the operating system is stored in the memory 502 for execution. In addition to any other responsibilities, the high-speed processor 530, executing a software architecture for the head-wearable apparatus 116, is used to manage data transfers with the high-speed wireless circuitry 532. In an example, the high-speed wireless circuitry 532 is configured to implement Institute of Electrical and Electronics Engineers (IEEE) 802.11 communication standards, also referred to herein as WI-FI®. In some examples, other high-speed communications standards can be implemented by the high-speed wireless circuitry 532.

The low-power wireless circuitry 534 and the high-speed wireless circuitry 532 of the head-wearable apparatus 116 can include short-range transceivers (Bluetooth™) and wireless wide, local, or wide area network transceivers (e.g., cellular or WI-FI®). The mobile device 114, including the transceivers communicating via the low-power wireless connection 512 and the high-speed wireless connection 514, can be implemented using details of the architecture of the head-wearable apparatus 116, as can other elements of the network 516.

The memory 502 includes any storage device capable of storing various data and applications, including, among other things, camera data generated by the left and right visible light cameras 506, the infrared camera 510, and the image processor 522, as well as images generated for display by the image display driver 520 on the image displays of the image display of optical assembly 518. While the memory 502 is shown as integrated with the high-speed circuitry 526, in some examples, the memory 502 can be an independent standalone element of the head-wearable apparatus 116. In certain such examples, electrical routing lines can provide a connection through a chip that includes the high-speed processor 530 from the image processor 522 or the low-power processor 536 to the memory 502. In some examples, the high-speed processor 530 can manage addressing of the memory 502 such that the low-power processor 536 will boot the high-speed processor 530 any time that a read or write operation involving the memory 502 is needed.

As shown in FIG. 5, the low-power processor 536 or the high-speed processor 530 of the head-wearable apparatus 116 can be coupled to the camera (visible light camera 506, infrared emitter 508, or infrared camera 510), the image display driver 520, the user input device 528 (e.g., touch sensor or push button), and the memory 502.

The head-wearable apparatus 116 is connected to a host computer. For example, the head-wearable apparatus 116 is paired with the mobile device 114 via the high-speed wireless connection 514 or connected to the server system 504 via the network 516. The server system 504 can be one or more computing devices as part of a service or network computing system, for example, that includes a processor, a memory, and a network communication interface to communicate over the network 516 with the mobile device 114 and the head-wearable apparatus 116.

The mobile device 114 includes a processor and a network communication interface coupled to the processor. The network communication interface allows for communication over the network 516, the low-power wireless connection 512, or the high-speed wireless connection 514. The mobile device 114 can further store at least portions of the instructions in the memory of the mobile device 114 to implement the functionality described herein.

Output components of the head-wearable apparatus 116 include visual components, such as a display, such as a liquid crystal display (LCD), a plasma display panel (PDP), a light-emitting diode (LED) display, a projector, or a waveguide. The image displays of the optical assembly are driven by the image display driver 520. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 504, such as the user input device 528, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 can also include additional peripheral device elements. Such peripheral device elements can include biometric sensors, additional sensors, or display elements integrated with the head-wearable apparatus 116. For example, peripheral device elements can include any I/O components, including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies include:
Electroencephalography (EEG) based BMIs, which record electrical activity in the brain using electrodes placed on the scalp.
Invasive BMIs, which use electrodes that are surgically implanted into the brain.
Optogenetics BMIs, which use light to control the activity of specific nerve cells in the brain.

Any biometric data collected by the biometric components is captured and stored with only user approval and deleted on user request. Further, such biometric data can be used for very limited purposes, such as identification verification. To ensure limited and authorized use of biometric information and other personally identifiable information (PII), access to this data is restricted to authorized personnel only, if at all. Any use of biometric data can be strictly limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., an accelerometer), gravitation sensor components, rotation sensor components (e.g., a gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 512 and high-speed wireless connection 514 from the mobile device 114 via the low-power wireless circuitry 534 or high-speed wireless circuitry 532.

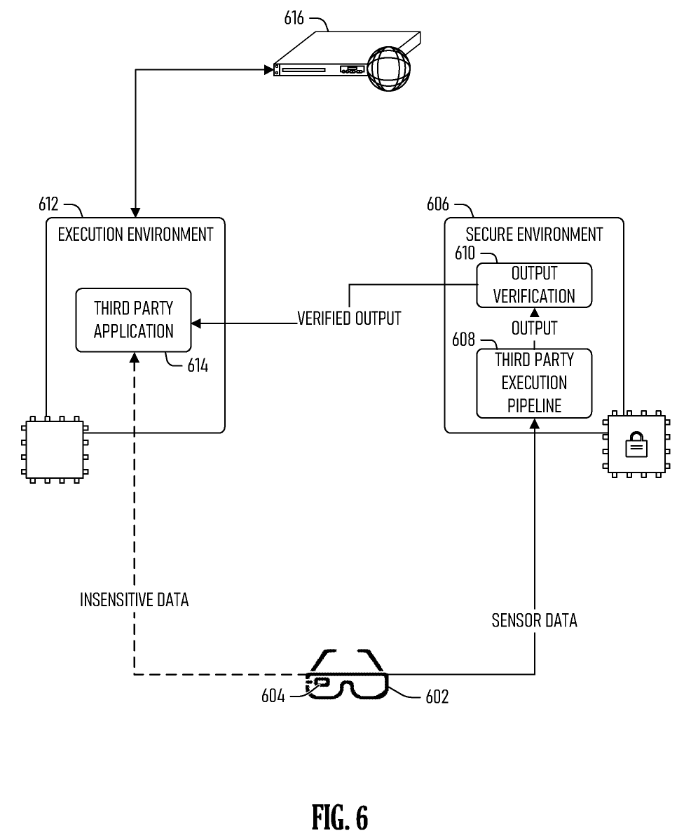

FIG. 6 illustrates an example of an environment including a system for securing sensor data, according to an embodiment. Here, the system can include a head-wearable apparatus 602, or other wearable device, a secure processing environment 606, and an external processing environment 612 (e.g., a network platform). Each of the head-wearable apparatus 602, the secure processing environment 606, or the external processing environment 612 can include processing circuitry, memory (e.g., RAM), or storage (e.g., power-stable storage such as flash devices). In an example, the secure processing environment 606 and the external processing environment 612 are virtual machines hosted by the same hardware (e.g., server or cluster of servers). In an example, the secure processing environment 606 and the external processing environment 612 are hosted in separate hardware.

The following examples generally describe the implementation for securing wearable camera data from the perspective of the secure processing environment 606 because the secure processing environment 606 controls the interactions with sensitive sensor data from the head-wearable apparatus 602. However, other arrangements, that conform to the following examples, could also be used, such as implementing the secure processing environment 606 in the head-wearable apparatus 602, where the sensor data is audio, tactile, or location (e.g., satellite positioning) data, network data (e.g., available networks, social network data, etc.), among other examples.

The secure processing environment 606 includes (e.g., has access to) an interface configured to obtain (e.g., retrieve or receive) sensor data from a sensor (e.g., a camera 604, microphone, antenna, etc.) of the head-wearable apparatus 602. While the sensor data can be processed, for example, by the head-wearable apparatus 602 to, for example, encode the data (e.g., in an image format, an audio format, etc.), the information in the sensor data is not otherwise redacted or modified. Thus, the sensor data can include sensitive data, such as an image of a private area occupied by the user, other people viewable by the user, etc. Accordingly, in an example, the sensor data is image data captured from the head-wearable apparatus 602, or other wearable device.

The secure processing environment 606 is configured to obtain an execution pipeline 608. The execution pipeline 608 is not a hardware pipeline, but rather a definition, code or instructions, schema, etc. that provides for processing of the sensor data. Thus, the execution pipeline 608 can be received as a list of steps to be taken, can be an executable package, or another mechanism that enables staged processing of the sensor data. Generally, the execution pipeline 608 is the mechanism by which a third-party developer can direct how the sensor data is to be processed into a result usable by the third-party developer. In an example, the secure processing environment 606 is configured to prevent the execution pipeline 608 from accessing any resource external to the secure processing environment 606. This can be accomplished by simply omitting network or storage instructions from the available instructions to the execution pipeline 608. In an example, instructions that access the network or storage can be intercepted during operation to prevent external resource access. In an example, the execution pipeline can be audited prior to execution to remove these instructions.

In an example, the execution pipeline 608 includes a machine learning model, such as a large language model (LLM), convolutional neural network (CNN), recurrent neural network (RNN), classifier, or other artificial intelligence (AI) model. For example, the machine learning model can identify persons in camera images to inform the user at, for example, a conference.

In an example, the execution pipeline 608 includes preprocessing. A variety of preprocessing can be useful, such as reducing data size, converting the sensor data to a more widely consumable format, compressing or uncompressing the sensor data, etc. In an example, the preprocessing is configured to transform the sensor data to input suitable to the machine learning model. This preprocessing can, for example, change data dimensionality to match the input space of the machine learning model, convert sensor data to floating-point numbers, or other transformations to enable the sensor data to be acceptable to the machine learning model.

In an example, the execution pipeline includes post-processing. Like pre-processing, post-processing can similarly transform output data to more convenient formats or forms, such as compressing the output, encrypting the output, among others. In an example, the post-processing is configured to transform machine learning model output to an output format. Here, the output format is the desired format for use by the external (e.g., insecure processing) by the developer, for example. Thus, these last examples illustrate that the execution pipeline 608 is a staged pipeline with pre-processing, central processing (e.g., the machine learning model), and post-processing defined by the developer and delivered to the secure processing environment 606.

Processing circuitry of the secure processing environment 606 is configured to invoke (e.g., execute, run, etc.) the execution pipeline 608. In an example, the processing circuitry is configured to invoke the execution pipeline 608 based on receipt of the sensor data. In this example, the receipt of the sensor data triggers the invocation and the execution pipeline 608 is otherwise dormant (e.g., sleeping, not running, etc.). However, in an example, the execution pipeline 608 is invoked once received, based on a schedule, or based on a directive provided with the execution pipeline delivery. Here, the invocation of the execution pipeline 608 can provoke the transfer of the sensor data from the head-wearable apparatus 602, which may otherwise not occur. In an example, invoking the execution pipeline 608 includes providing the sensor data as input to the execution pipeline 608 to produce an output from the execution pipeline 608.

The secure processing environment 606 includes verification circuitry 610 configured to match output of the execution pipeline 608 against a set of acceptable outputs to determine whether the output is acceptable. The verification circuitry 610 can be implemented as a separate hardware component, or integrated into other elements of the processing circuitry of the secure processing environment 606. The set of acceptable outputs provides a definition, built into the secure processing environment and thus outside of the control of the developer or other external actor, configured to prevent the release of sensitive data from the sensor data, as well as to ensure that the output data cannot be used to reconstruct the sensitive data. Thus, the set of acceptable outputs can include patterns to identify sensitive data, acceptance-denial lists, regular expressions, or even processing elements (e.g., a machine learning model) that the verification circuitry matches (e.g., executes against) the output of the execution pipeline 608. Members of the set of acceptable outputs can be in the form of an acceptor. Here, the output from the execution pipeline 608 is provided to the member of the set of acceptable outputs and, if the output is acceptable, the output is passed on. Otherwise, the output can be consumed and, in an example, an error message, log, or the like produced.

In an example, the set of acceptable outputs includes a pairwise association of an output type and an output format. In an example, the set of acceptable outputs includes one or more of a first output type of OBJECT CLASSIFIER paired with a first output format of a single integer value, a second output type of TWO-DIMENSIONAL OBJECT LOCATION paired with a second output format of two floating point values, a third output type of A BOUNDING BOX paired with a third output format of four floating point values, or a fourth output type of SIX-DEGREES-OF-FREEDOM POSE paired with a fourth output format of seven floating point values. These examples illustrate an association between the type of data to be consumed by the insecure developer instructions and the data format specific to that type. Note that these formats do not provide specific information about the sensor data (here image data), but rather simply provide an appropriate dimension coordinate.

In an example, to match the output against the set of acceptable outputs, the processing circuitry is configured to perform a value check of a value in the output format based on the sensor data. This value check can be used to ensure that the output value is conventional and not an attempt to encode the sensor data within the value. Thus, in an example, the value check is a range check, an encoding check, or a pattern check.

The processing circuitry of the secure processing environment 606 is configured to communicate (e.g., via a network interface or other interface) with the external processing environment 612 based on the output being acceptable (e.g., passing the verification circuitry 610). Thus, the external application 614 running in the external processing environment 612 can use the output that is based on the sensor data but scrubbed of sensitive data. Because there is no longer sensitive data in the output, the external application 614 can interact (e.g., via the external processing environment 612) with network resources, such as a cloud service 616. Further, the external application 614 can directly interact with data from the head-wearable apparatus 602 that is not sensitive. Thus, the external processing environment 612 enables external developers to provide rich AR experiences, including using sensor data results that are securely transformed from possibly sensitive data to acceptable outputs by the secure processing environment 606.

In an example, the secure processing environment 606 and the external processing environment 612 are included in a system. In an example, the system is configured to obtain a software package that includes the execution pipeline 608 and an unsecure pipeline (e.g., the external application 614). In an example, communicating the output to the external processing environment 612 includes providing the output to the unsecure pipeline executing in the external processing environment 612.

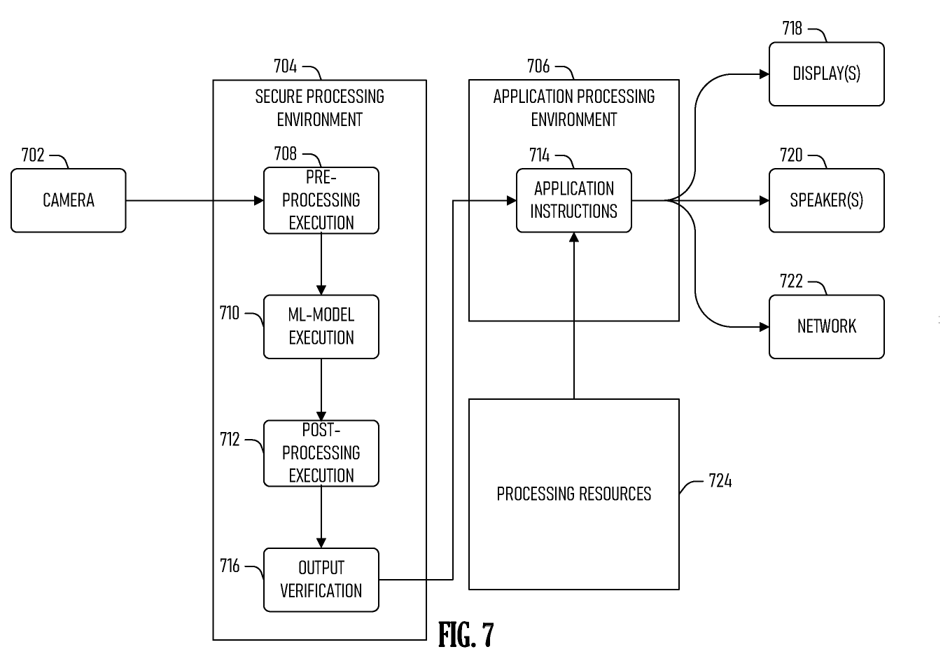

FIG. 7 illustrates an example of a system architecture for securing sensor data, according to an embodiment. This system architecture illustrates the use of a separate architecture for handling sensitive data in AR devices. Unlike traditional systems that rely on user permissions that can be bypassed once granted, distinct processing environments with technical barriers preventing data leakage are used here. The secure processing environment 704 implements a structured multi-stage pipeline that forces all data through validation, making it difficult for applications to access raw sensor (e.g., camera) data even after receiving user permissions.

Further, format-based security controls can be used in this structure, as opposed to simple allow/deny permissions common in other systems. For example, the illustrated system can enforce data minimization through defined output formats that restrict output to compact, well-defined data, such as single integers or small floating-point arrays, to exit the secure processing environment 704. This makes it technically difficult to reconstruct sensitive sensor data from the allowed outputs while still enabling useful functionality. The illustrated architecture also can provide robust memory or runtime protections that prevent third-party instructions from storing or retaining sensitive data, clearing processing buffers after use, or eliminating the ability to maintain state between operations that could lead to data leakage.

In an example, a developer integration model can be used that maintains security while enabling customization. For example, developers can provide their own processing code and machine learning models that execute in the secure processing environment 704, enabling innovative AR applications without compromising privacy protections. This is particularly useful for AR glasses, where the unique privacy concerns of head-mounted cameras can exhibit always on behavior that can capture the user's entire field of view. Thus, the described secure processing moves beyond simple permission models to provide continuous protection through technical isolation.

As shown in FIG. 7, two processing environments are provided, the secure processing environment 704 and the application processing environment 706. The secure processing environment can include components that handle privacy-sensitive data, such as camera data from a camera 702. The components of the secure processing environment 704 can include a pre-processing code execution component 708, a machine learning model execution component 710, a post-processing code execution component 712, or an output checker component 716.

The application processing environment 706 can include regular application code 714 (e.g., not subject to specific security concerns of sensitive data) and access displays 718, speakers 720, a network 722, and other system hardware (e.g., the additional processing resources 724, other sensor components, etc.) or software components. In an example, third-party code components include the pre-processing code execution component 708, the machine learning model execution component 710, and the post-processing code execution component 712.

As illustrated, a flow of data begins with the camera 702, the camera data entering the secure processing environment 704 and passing through the processing stages where only well-defined outputs that have passed through the output checker component 716 are permitted to reach the regular application code 714 in the application processing environment 706. Thus, the architecture separates sensitive data processing from general application functions, preventing privacy-concerning data from being leaked while still enabling developers to perform necessary processing on that data.

Here, the output checker component 716 provides a security control point that validates all data attempting to exit the secure processing environment 704. In an example, output checker component 716 is configured to implement validation rules to ensure that only well-defined, compact data formats can pass through, preventing any potential leakage of sensitive camera data. In an example, the output checker component 716 is configured to enforce a set of predefined output formats including, but not limited to, the following:
1. Single integer values (e.g., for object counting or classification results)
2. Two float values (representing 2D coordinates in the camera image)
3. Four float values (defining object bounding boxes)
4. Seven float values (encoding 6DOF poses)

In an example, output checker component 716 is configured to implement a rule-based validation. For example, hand-coded heuristics can be used to verify data compliance, boundary checking can be used, for example, to ensure that two-dimensional positions fall within valid image coordinates, or data type conformance to approved formats can be validated.

In an example, output checker component 716 is configured to implement machine learning-based detection by employing machine learning models to detect potential malicious behavior or to analyze output patterns for attempts to encode unauthorized data.

In an example, the output checker component 716 is configured to implement one or more security features. In an example, the output checker component 716 is configured to prevent transmission of raw sensor data. In an example, the output checker component 716 is configured to block attempts to encode sensitive data within approved formats. In an example, the output checker component 716 is configured to ensure that output data volume is sufficiently restricted to prevent image reconstruction. In an example, the output checker component 716 is configured to validate that output conforms to declared format specifications.

In an example, the output checker component 716 is configured to perform the following processing flow. First, processed data from a final stage of third-party processing (either post-processing code execution component 712 or earlier stages if subsequent stages aren't used) are received. Then, format validation and security checks are preformed. The output checker component 716 then only forwards validated data to the application processing environment 706 and blocks and rejects any non-conforming data. Thus, the illustrated placement of the output checker component 716 in the architecture ensures that all data must pass through validation before reaching the regular application code 714, providing a robust security boundary between sensitive data processing and general application functions.

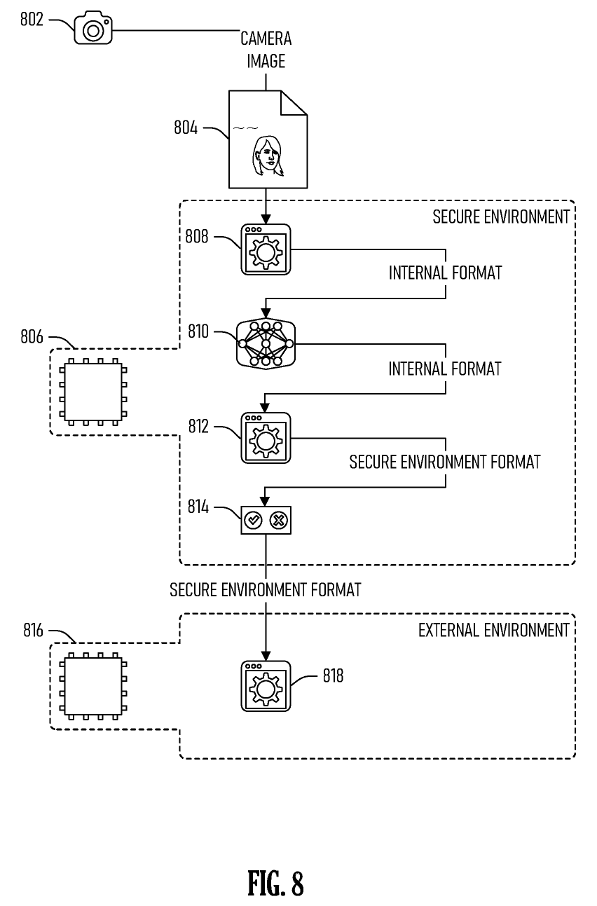

FIG. 8 illustrates an example of a secure processing pipeline, according to an embodiment. The pipeline can be divided into an input flow, middle processing, and final processing. The input flow starts with a camera image 804 from the camera 802 that moves into pre-processing code execution 808 to produce an internal format acceptable to the next stage of the pipeline. The middle processing continues to machine learning model execution 810 to produce an output. Then final processing is engaged to move the output of the middle processing to post-processing code execution 812 to transform the output to a format acceptable to the secure environment 806. This secure environment format is then tested by the output checker 814 for validation. The output checker 814 is configured to pass only approved data to regular application code 818 in an external environment 816.

The illustrated processing path illustrates data (e.g., data format) transition between processing stages to system-defined validated formats (e.g., scrubbed of sensitive data) before reaching the regular application code 818, ensuring that sensitive camera data can only exit the secure environment in pre-approved, restricted formats. In an example, the output format can incorporate a variety of elements beyond basic integer or floating point value formats. For example, output formats can include Boolean values for simple detection results, fixed-length arrays for multiple detections, enumerated types for classification results, or structured data with predefined schemas and size limits. This variety of output formats can be used to prevent sensitive data leakage while providing developers with flexibility for different application scenarios. The illustrated processing provides a unidirectional flow of data such that, after data enters the secure environment 806, the data can only exit through the output checker 814 in an approved format.

In an example, the secure environment 806 is not restricted to camera data but can process various sensitive data streams from wearable devices (e.g., AR glasses), including audio input, satellite or other location data, and other sensor data. In an example, each type of sensitive data has a respective set of acceptable output formats while maintaining the core security principles. In an example, the secure environment 806 can be implemented as separate compute unit for enhanced isolation, a secure enclave within the same processor as the external environment 816, or other techniques used to enforce data isolation (e.g., virtual machine environments or the like).

As noted above, the output checker 814 can be implemented with varying levels of sophistication. For example, the output checker 814 can be configured to use machine learning-based anomaly detection to identify suspicious patterns, to use rule-based heuristics for format compliance, or to combine multiple validation approaches. In an example, different security tiers can be used. For example, a basic validation tier can be used for low-risk applications and an enhanced security protocol can be used for highly sensitive data. In an example, configurable security policies can be used based on specific data types or use cases.

This processing pipeline architecture offers flexibility in implementation. For example, while the illustrated example three stages (pre-processing code execution 808, machine learning model execution 810, and post-processing code execution 812), parallel processing paths, conditional execution of stages, or multiple machine learning models in sequence can also be used. In an example, various approaches to memory management can be used. For example, immediate clearing of processing buffers, encrypted memory regions, or time-limited data retention can help to ensure sensitive data is not compromised. In an example, functionality to provide the processing pipeline or to received output can be exposed through different interfaces, such as application programming interface (API) integration to software development kits (SDKs) with pre-built components, or a configuration-based setup without custom execution pipeline instructions.

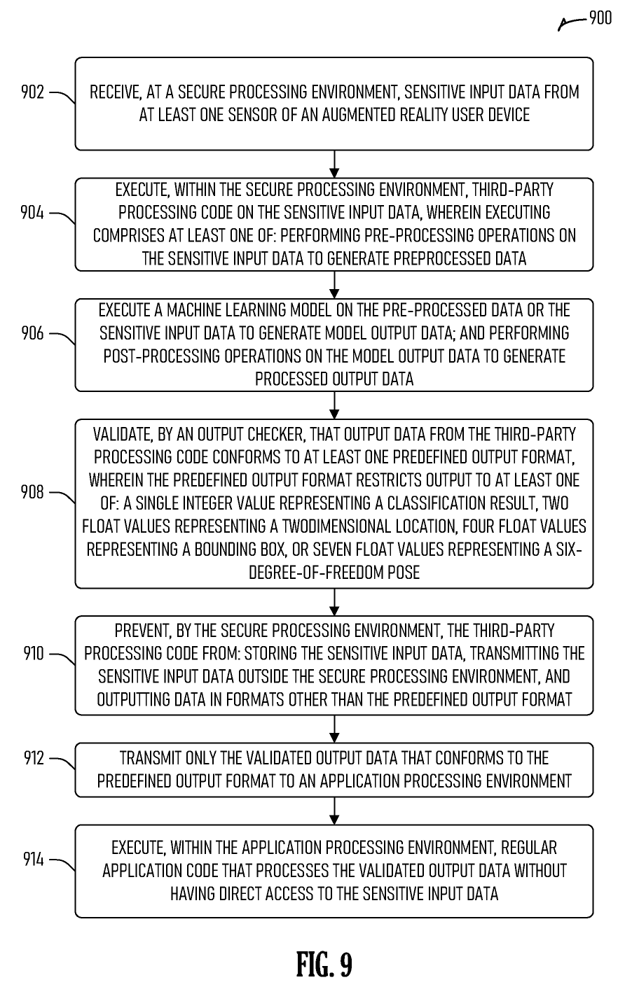

FIG. 9 is a flow diagram of an example of a method 900 for securing sensor data, according to an embodiment. The operations of the method 900 are performed by computer hardware, such as that described above or below (e.g., processing circuitry) Thus, in an example, the method 900 can be embodied in computer-readable instructions for execution by one or more computer processors such that the operations of the method can be performed in part or in whole by head-wearable apparatus (e.g., the head-wearable apparatus 116). In an example, at least some of the operations of the method 900 can be deployed on various other hardware configurations (e.g., the mobile device 114, the computer client device 118), and the method 900 is not intended to be limited to head-wearable apparatus 116 or any components or systems mentioned above.

At operation 902, sensitive input data from at least one sensor of an AR user device is received a secure processing environment.

At operation 904, third-party processing code is executed within the secure processing environment on the sensitive input data. In an example, executing the code includes performing a pre-processing operation on the sensitive input data to generate pre-processed data.

At operation 906, a machine learning model is executed on the sensitive input data (e.g., the pre-processed data) to generate model output data. In an example, a post-processing operation is performed on the model output data to generate processed output data.

At operation 908, an output checker validates that output data from the third-party processing code conforms to at least one predefined output format. In an example, the predefined output format restricts output to at least one of a single integer value representing a classification result, two float values representing a two-dimensional location, four float values representing a bounding box, or seven float values representing a six-degree-of-freedom pose.

At operation 910, the secure processing environment prevents the third-party processing code from storing the sensitive input data, transmitting the sensitive input data outside the secure processing environment, or outputting data in formats other than the predefined output format.

At operation 912, only the validated output that conforms to the predefined output format is transmitted to an application processing environment.

At operation 914, regular application code is executed within the application processing environment. Here, the regular application code is configured to process the validated output data without having direct access to the sensitive input data.

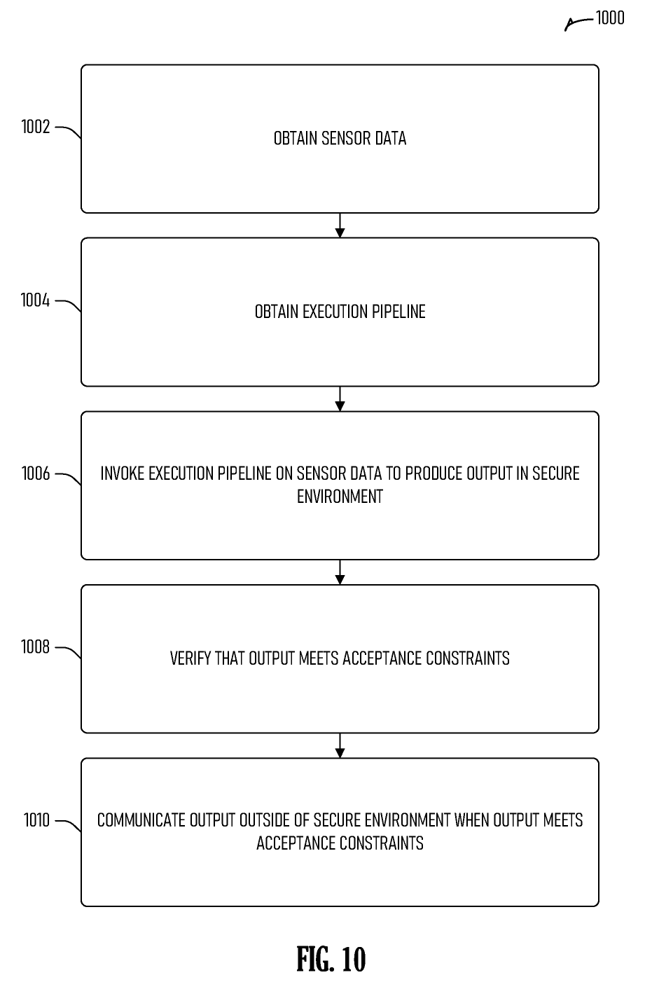

FIG. 10 is a flow diagram of an example of a method 1000 for securing sensor data, according to an embodiment. The operations of the method 1000 are performed by computer hardware, such as that described above or below (e.g., processing circuitry).

At operation 1002, data from a sensor is obtained (e.g., retrieve, received, etc.) at an interface of a secure processing environment. In an example, the sensor data is image data captured from a wearable device.

At operation 1004, an execution pipeline (e.g., definition, code or instructions, schema, etc.) is obtained by the secure processing environment. In an example, the secure processing environment is configured to prevent the execution pipeline from accessing any resource external to the secure processing environment.

In an example, the execution pipeline includes a machine learning model. In an example, the execution pipeline includes preprocessing. In an example, the preprocessing is configured to transform the sensor data to input suitable to the machine learning model. In an example, the execution pipeline includes post-processing. In an example, the post-processing is configured to transform machine learning model output to an output format.

At operation 1006, the execution pipeline is invoked (e.g., executed, run, etc.) by processing circuitry of the secure processing environment based on receipt of the sensor data. Here, invoking the execution pipeline includes providing the sensor data as input to the execution pipeline to produce an output from the execution pipeline.

At operation 1008, the output is matched against a set of acceptable outputs to determine that the output is acceptable. In an example, the set of acceptable outputs includes a pairwise association of an output type and an output format. In an example, the set of acceptable outputs includes one or more of a first output type of OBJECT CLASSIFIER paired with a first output format of a single integer value, a second output type of TWO-DIMENSIONAL OBJECT LOCATION paired with a second output format of two floating point values, a third output type of A BOUNDING BOX paired with a third output format of four floating point values, or a fourth output type of SIX-DEGREES-OF-FREEDOM POSE paired with a fourth output format of seven floating point values.

In an example, matching the output against the set of acceptable outputs includes performing a value check of a value in the output format based on the sensor data. In an example, the value check is a range check, an encoding check, or a pattern check.

At operation 1010, the output is communicated (e.g., via the interface of the secure processing environment) to an external processing environment based on the output being acceptable. In an example, the secure processing environment and the external processing environment are included in a system. In an example, the system is configured to obtain a software package that includes the execution pipeline and an unsecure pipeline. In an example, communicating the output to the external processing environment includes providing the output to the unsecure pipeline executing in the external processing environment.

In an example, the operations of the method 1000 can further include obtaining second data from the sensor, obtaining a second execution pipeline, and invoking the second execution pipeline on the second data to produce a second output. Here, the operations can include matching the second output against the set of acceptable outputs to determine that the output is unacceptable and discarding the second output to prevent communication of data derived from the second data from leaving the secure processing environment. In an example, the operations of the method 1000 can include communicating an error condition based on discarding the second output.

### MACHINE ARCHITECTURE

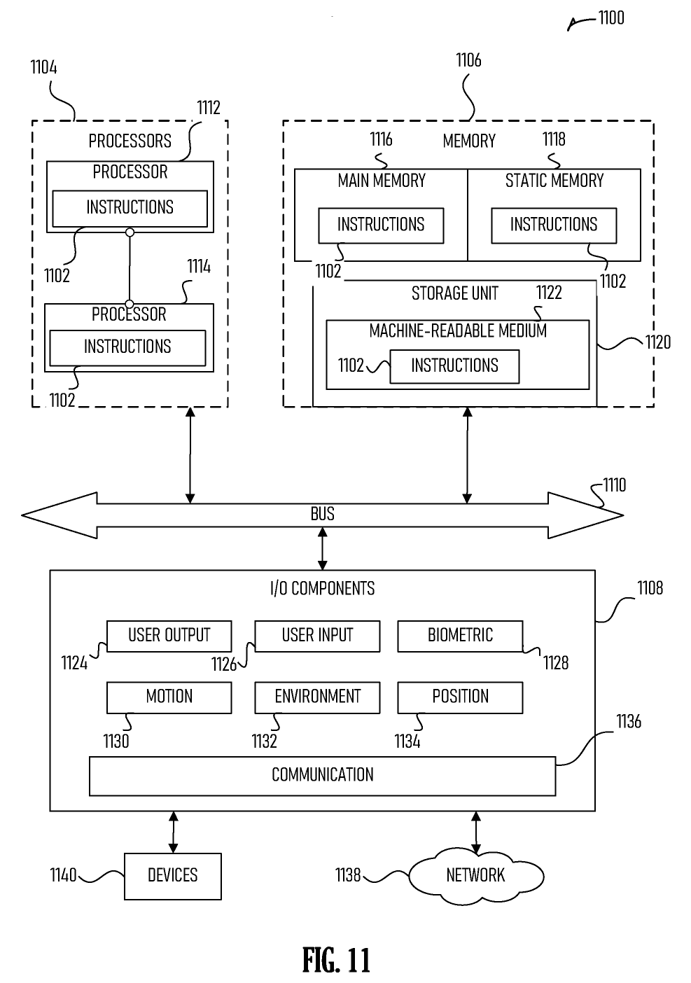

FIG. 11 illustrates an example of a machine 1100 in the form of a computer system within which a set of instructions 1102 (e.g., software, a program, an application, an applet, an app, or other executable code) can be executed to cause the machine1100 to perform any one or more of the methodologies described herein, according to an embodiment For example, the instructions 1102 can cause the machine 1100 to execute any one or more of the methods described herein. The instructions 1102 transform the general, non-programmed machine 1100 into a particular machine 1100 programmed to carry out the described and illustrated functions in the manner described. The machine 1100 can operate as a standalone device or can be coupled (e.g., networked) to other machines. In a networked deployment, the machine 1100 can operate in the capacity of a server machine or a client machine in a server-client network environment, or as a peer machine in a peer-to-peer (or distributed) network environment. The machine 1100 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, can comprise the user system 102 or any one of multiple server devices forming part of the interaction server system 100. In some examples, the machine 1100 can also comprise both client and server systems, with certain operations of a particular method or algorithm being performed on the server-side and with certain operations of the particular method or algorithm being performed on the client-side.

The machine 1100 can include processors 1104, memory 1106, and input/output (I/O) components 1108, which can be configured to communicate with each other via a bus 1110. In an example, the processors 1104 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, a processor 1112 and a processor 1114 that execute the instructions 1102. The term “processor” is intended to include multi-core processors that can comprise two or more independent processors (sometimes referred to as “cores”) that can execute instructions contemporaneously. Although FIG. 11 shows multiple processors 1104, the machine 1100 can include a single processor with a single core, a single processor with multiple cores (e.g., a multi-core processor), multiple processors with a single core, multiple processors with multiple cores, or any combination thereof.

Circuitry (e.g., processing circuitry) is a collection of circuits implemented in tangible entities of the machine 1100 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

The memory 1106 includes a main memory 1116, a static memory 1118, and a storage unit 1120, both accessible to the processors 1104 via the bus 1110. The main memory 1116, the static memory 1118, and storage unit 1120 store the instructions 1102 embodying any one or more of the methodologies or functions described herein. The instructions 1102 can also reside, completely or partially, within the main memory 1116, within the static memory 1118, within a machine-readable medium 1122 within the storage unit 1120, within at least one of the processors 1104 (e.g., within the processor's cache memory), or any suitable combination thereof, during execution thereof by the machine 1100.

The I/O components 1108 can include a wide variety of components to receive input, provide output, produce output, transmit information, exchange information, capture measurements, and so on. The specific I/O components 1108 that are included in a particular machine will depend on the type of machine. For example, portable machines such as mobile phones can include a touch input device or other such input mechanisms, while a headless server machine will likely not include such a touch input device. It will be appreciated that the I/O components 1108 can include many other components that are not shown in FIG. 11. In various examples, the I/O components 1108 can include user output components 1124 and user input components 1126. The user output components 1124 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 can include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies include:
Electroencephalography (EEG) based BMIs, which record electrical activity in the brain using electrodes placed on the scalp.
Invasive BMIs, which use electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data can be used for very limited purposes, such as identification verification. To ensure limited and authorized use of biometric information and other personally identifiable information (PII), access to this data is restricted to authorized personnel only, if at all. Any use of biometric data can be strictly limited to identification verification purposes, and the data is not shared or sold to any third party without the explicit consent of the user. In addition, appropriate technical and organizational measures are implemented to ensure the security and confidentiality of this sensitive information.

The motion components 1130 include acceleration sensor components (e.g., accelerometer), gravitation sensor components, rotation sensor components (e.g., gyroscope).

The environmental components 1132 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment.

With respect to cameras, the user system 102 can have a camera system comprising, for example, front cameras on a front surface of the user system 102 and rear cameras on a rear surface of the user system 102. The front cameras can, for example, be used to capture still images and video of a user of the user system 102 (e.g., “selfies”), which can then be augmented with augmentation data (e.g., filters) described above. The rear cameras can, for example, be used to capture still images and videos in a more traditional camera mode, with these images similarly being augmented with augmentation data. In addition to front and rear cameras, the user system 102 can also include a 360° camera for capturing 360° photographs and videos.

Further, the camera system of the user system 102 can include dual rear cameras (e.g., a primary camera as well as a depth-sensing camera), or even triple, quad, or penta rear camera configurations on the front and rear sides of the user system 102. These multiple camera systems can include a wide camera, an ultra-wide camera, a telephoto camera, a macro camera, and a depth sensor, for example.

The position components 1134 include location sensor components (e.g., a GPS receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1108 further include communication components 1136 operable to couple the machine 1100 to a network 1138 or devices 1140 via respective couplings or connections. For example, the communication components 1136 can include a network interface component or another suitable device to interface with the network 1138. In further examples, the communication components 1136 can include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 1140 can be another machine or any of a wide variety of peripheral devices (e.g., a peripheral device coupled via a USB).

Moreover, the communication components 1136 can detect identifiers or include components operable to detect identifiers. For example, the communication components 1136 can include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as Quick Response (QR) code, Aztec code, Data Matrix, Dataglyph^{TM}, MaxiCode, PDF417, Ultra Code, UCC RSS-2D bar code, and other optical codes), or acoustic detection components (e.g., microphones to identify tagged audio signals). In addition, a variety of information can be derived via the communication components 1136, such as location via Internet Protocol (IP) geolocation, location via Wi-Fi® signal triangulation, location via detecting an NFC beacon signal that can indicate a particular location, and so forth.

The various memories (e.g., main memory 1116, static memory 1118, and memory of the processors 1104) and storage unit 1120 can store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 can be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 can be transmitted or received using a transmission medium via a coupling (e.g., a peer-to-peer coupling) to the devices 1140.

### SOFTWARE ARCHITECTURE

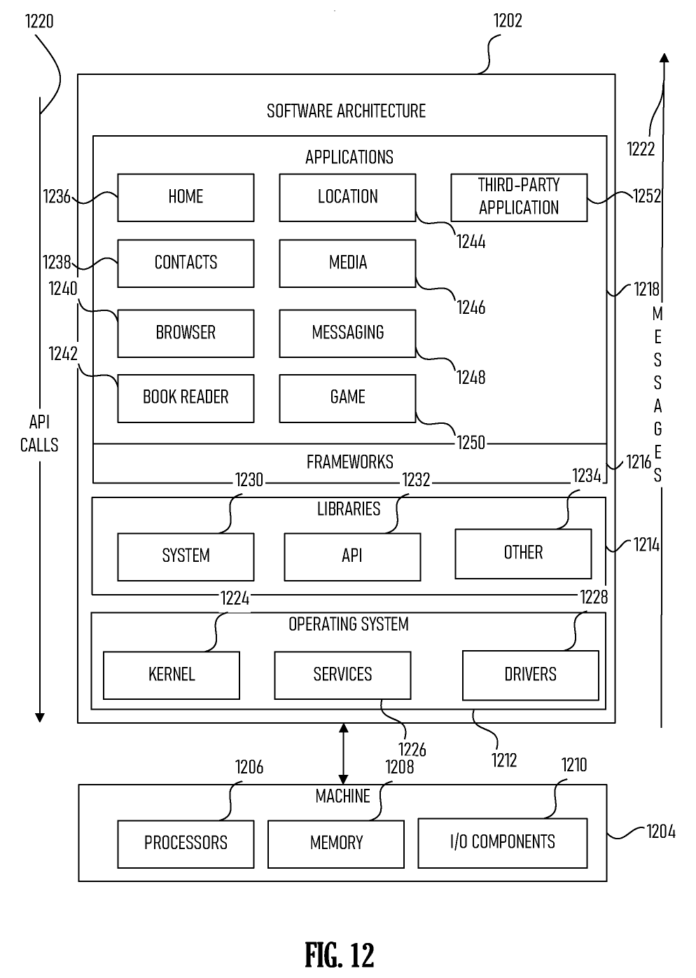

FIG. 12 illustrates an example of a software architecture 1202 within which examples can be implemented, according to an embodiment. In an example, , the software architecture 1202 can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematical functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which can be specific to a particular operating system or platform.

In an example, the applications 1218 can include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of the particular platform) can be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

### EXAMPLE STATEMENTS

Example 1 is a method for securing sensor data, the method comprising: obtaining, at an interface of a secure processing environment, sensor data from a sensor; obtaining, by the secure processing environment, an execution pipeline; invoking, by processing circuitry of the secure processing environment, the execution pipeline based on receipt of the sensor data, wherein invoking the execution pipeline includes providing the sensor data as input to the execution pipeline to produce an output from the execution pipeline; matching the output against a set of acceptable outputs to determine that the output is acceptable; and communicating the output, based on the output being acceptable, to an external processing environment.

In Example 2, the subject matter of Example 1, wherein the set of acceptable outputs includes a pairwise association of an output type and an output format.

In Example 3, the subject matter of Example 2, wherein the set of acceptable outputs includes: a first output type of OBJECT CLASSIFIER paired with a first output format of a single integer value; a second output type of TWO-DIMENSIONAL OBJECT LOCATION paired with a second output format of two floating-point values; a third output type of A BOUNDING BOX paired with a third output format of four floating-point values; and a fourth output type of SIX-DEGREES-OF-FREEDOM POSE paired with a fourth output format of seven floating-point values.

In Example 4, the subject matter of any of Examples 2–3, wherein matching the output against the set of acceptable outputs includes performing a value check of a value in the output format based on the sensor data.

In Example 5, the subject matter of Example 4, wherein the value check is a range check, an encoding check, or a pattern check.

In Example 6, the subject matter of any of Examples 1–5, comprising: obtaining second sensor data from the sensor; obtaining a second execution pipeline; invoking the second execution pipeline on the second sensor data to produce a second output; matching the second output against the set of acceptable outputs to determine that the second output is unacceptable; and discarding the second output to prevent communication of data derived from the second sensor data from leaving the secure processing environment.

In Example 7, the subject matter of Example 6, comprising communicating an error condition based on discarding the second output.

In Example 8, the subject matter of any of Examples 1–7, wherein the execution pipeline includes a machine learning model.

In Example 9, the subject matter of Example 8, wherein the execution pipeline includes preprocessing, wherein the preprocessing is configured to transform the sensor data into input suitable for the machine learning model.

In Example 10, the subject matter of any of Examples 8–9, wherein the execution pipeline includes post-processing, wherein the post-processing is configured to transform machine learning model output into an output format.

In Example 11, the subject matter of any of Examples 1–10, wherein the secure processing environment and the external processing environment are included in a system, the system configured to obtain a software package that includes the execution pipeline and an unsecure pipeline, and wherein communicating the output to the external processing environment includes providing the output to the unsecure pipeline executing in the external processing environment.

In Example 12, the subject matter of any of Examples 1–11, wherein the secure processing environment is configured to prevent the execution pipeline from accessing any resource external to the secure processing environment.

In Example 13, the subject matter of any of Examples 1–12, wherein the sensor data is image data captured from a wearable device.

Example 14 is a system for securing sensor data, the system comprising: at least one processor; and at least one memory component storing instructions that, when executed by the at least one processor, cause the at least one processor to perform operations comprising: obtaining, at an interface of a secure processing environment, sensor data from a sensor; obtaining, by the secure processing environment, an execution pipeline; invoking, by processing circuitry of the secure processing environment, the execution pipeline based on receipt of the sensor data, wherein invoking the execution pipeline includes providing the sensor data as input to the execution pipeline to produce an output from the execution pipeline; matching the output against a set of acceptable outputs to determine that the output is acceptable; and communicating the output, based on the output being acceptable, to an external processing environment.

In Example 15, the subject matter of Example 14, wherein the set of acceptable outputs includes a pairwise association of an output type and an output format.

In Example 16, the subject matter of Example 15, wherein the set of acceptable outputs includes: a first output type of OBJECT CLASSIFIER paired with a first output format of a single integer value; a second output type of TWO-DIMENSIONAL OBJECT LOCATION paired with a second output format of two floating-point values; a third output type of A BOUNDING BOX paired with a third output format of four floating-point values; and a fourth output type of SIX-DEGREES-OF-FREEDOM POSE paired with a fourth output format of seven floating-point values.

In Example 17, the subject matter of any of Examples 15–16, wherein matching the output against the set of acceptable outputs includes performing a value check of a value in the output format based on the sensor data.

In Example 18, the subject matter of Example 17, wherein the value check is a range check, an encoding check, or a pattern check.

In Example 19, the subject matter of any of Examples 14–18, wherein the operations comprise: obtaining second sensor data from the sensor; obtaining a second execution pipeline; invoking the second execution pipeline on the second sensor data to produce a second output; matching the second output against the set of acceptable outputs to determine that the second output is unacceptable; and discarding the second output to prevent communication of data derived from the second sensor data from leaving the secure processing environment.

In Example 20, the subject matter of Example 19, wherein the operations comprise communicating an error condition based on discarding the second output.

In Example 21, the subject matter of any of Examples 14–20, wherein the execution pipeline includes a machine learning model.

In Example 22, the subject matter of Example 21, wherein the execution pipeline includes preprocessing, wherein the preprocessing is configured to transform the sensor data into input suitable for the machine learning model.

In Example 23, the subject matter of any of Examples 21–22, wherein the execution pipeline includes post-processing, wherein the post-processing is configured to transform machine learning model output into an output format.

In Example 24, the subject matter of any of Examples 14–23, wherein the secure processing environment and the external processing environment are included in the system, and wherein the system is configured to obtain a software package that includes the execution pipeline and an unsecure pipeline, and wherein communicating the output to the external processing environment includes providing the output to the unsecure pipeline executing in the external processing environment.

In Example 25, the subject matter of any of Examples 14–24, wherein the secure processing environment is configured to prevent the execution pipeline from accessing any resource external to the secure processing environment.

In Example 26, the subject matter of any of Examples 14–25, wherein the sensor data is image data captured from a wearable device.

Example 27 is a machine-readable medium including instructions for securing sensor data, the instructions, when executed by processing circuitry, cause the processing circuitry to perform operations comprising: obtaining, at an interface of a secure processing environment, sensor data from a sensor; obtaining, by the secure processing environment, an execution pipeline; invoking, by processing circuitry of the secure processing environment, the execution pipeline based on receipt of the sensor data, wherein invoking the execution pipeline includes providing the sensor data as input to the execution pipeline to produce an output from the execution pipeline; matching the output against a set of acceptable outputs to determine that the output is acceptable; and communicating the output, based on the output being acceptable, to an external processing environment.

In Example 28, the subject matter of Example 27, wherein the set of acceptable outputs includes a pairwise association of an output type and an output format.

In Example 29, the subject matter of Example 28, wherein the set of acceptable outputs includes: a first output type of OBJECT CLASSIFIER paired with a first output format of a single integer value; a second output type of TWO-DIMENSIONAL OBJECT LOCATION paired with a second output format of two floating-point values; a third output type of A BOUNDING BOX paired with a third output format of four floating-point values; and a fourth output type of SIX-DEGREES-OF-FREEDOM POSE paired with a fourth output format of seven floating-point values.

In Example 30, the subject matter of any of Examples 28–29, wherein matching the output against the set of acceptable outputs includes performing a value check of a value in the output format based on the sensor data.

In Example 31, the subject matter of Example 30, wherein the value check is a range check, an encoding check, or a pattern check.

In Example 32, the subject matter of any of Examples 27–31, wherein the operations comprise: obtaining second sensor data from the sensor; obtaining a second execution pipeline; invoking the second execution pipeline on the second sensor data to produce a second output; matching the second output against the set of acceptable outputs to determine that the second output is unacceptable; and discarding the second output to prevent communication of data derived from the second sensor data from leaving the secure processing environment.

In Example 33, the subject matter of Example 32, wherein the operations comprise communicating an error condition based on discarding the second output.

In Example 34, the subject matter of any of Examples 27–33, wherein the execution pipeline includes a machine learning model.

In Example 35, the subject matter of Example 34, wherein the execution pipeline includes preprocessing, wherein the preprocessing is configured to transform the sensor data into input suitable for the machine learning model.

In Example 36, the subject matter of any of Examples 34–35, wherein the execution pipeline includes post-processing, wherein the post-processing is configured to transform machine learning model output into an output format.

In Example 37, the subject matter of any of Examples 27–36, wherein the secure processing environment and the external processing environment are included in a system, the system configured to obtain a software package that includes the execution pipeline and an unsecure pipeline, and wherein communicating the output to the external processing environment includes providing the output to the unsecure pipeline executing in the external processing environment.

In Example 38, the subject matter of any of Examples 27–37, wherein the secure processing environment is configured to prevent the execution pipeline from accessing any resource external to the secure processing environment.

In Example 39, the subject matter of any of Examples 27–38, wherein the sensor data is image data captured from a wearable device.

Example 40 is a system for securing sensor data, the system comprising: means for obtaining, at an interface of a secure processing environment, sensor data from a sensor; means for obtaining, by the secure processing environment, an execution pipeline; means for invoking, by processing circuitry of the secure processing environment, the execution pipeline based on receipt of the sensor data, wherein invoking the execution pipeline includes providing the sensor data as input to the execution pipeline to produce an output from the execution pipeline; means for matching the output against a set of acceptable outputs to determine that the output is acceptable; and means for communicating the output, based on the output being acceptable, to an external processing environment.

In Example 41, the subject matter of Example 40, wherein the set of acceptable outputs includes a pairwise association of an output type and an output format.

In Example 42, the subject matter of Example 41, wherein the set of acceptable outputs includes: a first output type of OBJECT CLASSIFIER paired with a first output format of a single integer value; a second output type of TWO-DIMENSIONAL OBJECT LOCATION paired with a second output format of two floating-point values; a third output type of A BOUNDING BOX paired with a third output format of four floating-point values; and a fourth output type of SIX-DEGREES-OF-FREEDOM POSE paired with a fourth output format of seven floating-point values.

In Example 43, the subject matter of any of Examples 41–42, wherein the means for matching the output against the set of acceptable outputs include means for performing a value check of a value in the output format based on the sensor data.

In Example 44, the subject matter of Example 43, wherein the value check is a range check, an encoding check, or a pattern check.

In Example 45, the subject matter of any of Examples 40–44, comprising: means for obtaining second sensor data from the sensor; means for obtaining a second execution pipeline; means for invoking the second execution pipeline on the second sensor data to produce a second output; means for matching the second output against the set of acceptable outputs to determine that the second output is unacceptable; and means for discarding the second output to prevent communication of data derived from the second sensor data from leaving the secure processing environment.

In Example 46, the subject matter of Example 45, comprising means for communicating an error condition based on discarding the second output.

In Example 47, the subject matter of any of Examples 40–46, wherein the execution pipeline includes a machine learning model.

In Example 48, the subject matter of Example 47, wherein the execution pipeline includes preprocessing, wherein the preprocessing is configured to transform the sensor data into input suitable for the machine learning model.

In Example 49, the subject matter of any of Examples 47–48, wherein the execution pipeline includes post-processing, wherein the post-processing is configured to transform machine learning model output into an output format.

In Example 50, the subject matter of any of Examples 40–49, wherein the secure processing environment and the external processing environment are included in the system, the system configured to obtain a software package that includes the execution pipeline and an unsecure pipeline, and wherein communicating the output to the external processing environment includes providing the output to the unsecure pipeline executing in the external processing environment.

In Example 51, the subject matter of any of Examples 40–50, wherein the secure processing environment is configured to prevent the execution pipeline from accessing any resource external to the secure processing environment.

In Example 52, the subject matter of any of Examples 40–51, wherein the sensor data is image data captured from a wearable device.

Example 53 is at least one machine-readable medium including instructions that, when executed by processing circuitry, cause the processing circuitry to perform operations to implement any of Examples 1–52.

Example 54 is an apparatus comprising means to implement any of Examples 1–52.

Example 55 is a system to implement any of Examples 1–52.

Example 56 is a method to implement any of Examples 1–52.

### TERM EXAMPLES

“Carrier signal” refers, for example, to any intangible medium that is capable of storing, encoding, or carrying instructions for execution by a machine and includes digital or analog communications signals or other intangible media to facilitate communication of such instructions. Instructions can be transmitted or received over a network using a transmission medium via a network interface device.

“Client device” refers, for example, to any machine that interfaces to a communications network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Communication network” refers, for example, to one or more portions of a network that can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function or related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implementedcomponents that operate to perform one or more operations or functions described herein. As used herein, “processor-implemented component” refers to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and can be used interchangeably in this disclosure.

“Ephemeral message” refers, for example, to a message that is accessible for a time-limited duration. An ephemeral message can be a text, an image, a video, and the like. The access time for the ephemeral message can be set by the message sender. Alternatively, the access time can be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and can be used interchangeably in this disclosure.

“User device” refers, for example, to a device accessed, controlled, or owned by a user and with which the user interacts to perform an action or interaction on the user device, including an interaction with other users or computer systems.

What is claimed is:

1. A method comprising:
obtaining, at an interface of a secure processing environment, sensor data from a sensor;
obtaining, by the secure processing environment, an execution pipeline;
invoking, by processing circuitry of the secure processing environment, the execution pipeline based on receipt of the sensor data, wherein invoking the execution pipeline includes providing the sensor data as input to the execution pipeline to produce an output from the execution pipeline;
matching the output against a set of acceptable outputs to determine that the output is acceptable; and
communicating the output, based on the output being acceptable, to an external processing environment.

2. The method of claim 1, wherein the set of acceptable outputs includes a pairwise association of an output type and an output format.

3. The method of claim 2, wherein the set of acceptable outputs includes:
a first output type of OBJECT CLASSIFIER paired with a first output format of a single integer value;
a second output type of TWO-DIMENSIONAL OBJECT LOCATION paired with a second output format of two floating-point values;
a third output type of A BOUNDING BOX paired with a third output format of four floating-point values; and
a fourth output type of SIX-DEGREES-OF-FREEDOM POSE paired with a fourth output format of seven floating-point values.

4. The method of claim 2, wherein matching the output against the set of acceptable outputs includes performing a value check of a value in the output format based on the sensor data.

5. The method of claim 4, wherein the value check is a range check, an encoding check, or a pattern check.

6. The method of claim 1, comprising:
obtaining second sensor data from the sensor;
obtaining a second execution pipeline;
invoking the second execution pipeline on the second sensor data to produce a second output;
matching the second output against the set of acceptable outputs to determine that the second output is unacceptable; and
discarding the second output to prevent communication of data derived from the second sensor data from leaving the secure processing environment.

7. The method of claim 6, comprising communicating an error condition based on discarding the second output.

8. The method of claim 1, wherein the execution pipeline includes a machine learning model.

9. The method of claim 8, wherein the execution pipeline includes preprocessing, wherein the preprocessing is configured to transform the sensor data into input suitable for the machine learning model.

10. The method of claim 8, wherein the execution pipeline includes post-processing, wherein the post-processing is configured to transform machine learning model output into an output format.

11. The method of claim 1, wherein the secure processing environment and the external processing environment are included in a system, the system configured to obtain a software package that includes the execution pipeline and an unsecure pipeline, and wherein communicating the output to the external processing environment includes providing the output to the unsecure pipeline executing in the external processing environment.

12. The method of claim 1, wherein the secure processing environment is configured to prevent the execution pipeline from accessing any resource external to the secure processing environment.

13. The method of claim 1, wherein the sensor data is image data captured from a wearable device.

14. A system comprising:
at least one processor; and
at least one memory component storing instructions that, when executed by the at least one processor, cause the at least one processor to perform operations comprising:
obtaining, at an interface of a secure processing environment, sensor data from a sensor;
obtaining, by the secure processing environment, an execution pipeline;
invoking, by processing circuitry of the secure processing environment, the execution pipeline based on receipt of the sensor data, wherein invoking the execution pipeline includes providing the sensor data as input to the execution pipeline to produce an output from the execution pipeline;
matching the output against a set of acceptable outputs to determine that the output is acceptable; and
communicating the output, based on the output being acceptable, to an external processing environment.

15. The system of claim 14, wherein the set of acceptable outputs includes a pairwise association of an output type and an output format.

16. The system of claim 15, wherein the set of acceptable outputs includes:
a first output type of OBJECT CLASSIFIER paired with a first output format of a single integer value;
a second output type of TWO-DIMENSIONAL OBJECT LOCATION paired with a second output format of two floating-point values;
a third output type of A BOUNDING BOX paired with a third output format of four floating-point values; and
a fourth output type of SIX-DEGREES-OF-FREEDOM POSE paired with a fourth output format of seven floating-point values.

17. The system of claim 14, wherein the operations comprise:
obtaining second sensor data from the sensor;
obtaining a second execution pipeline;
invoking the second execution pipeline on the second sensor data to produce a second output;
matching the second output against the set of acceptable outputs to determine that the second output is unacceptable; and
discarding the second output to prevent communication of data derived from the second sensor data from leaving the secure processing environment.

18. The system of claim 14, wherein the execution pipeline includes a machine learning model.

19. The system of claim 14, wherein the sensor data is image data captured from a wearable device.

20. A non-transitory machine-readable medium including instructions for securing sensor data, the instructions, when executed by processing circuitry, cause the processing circuitry to perform operations comprising:
obtaining, at an interface of a secure processing environment, sensor data from a sensor;
obtaining, by the secure processing environment, an execution pipeline;
invoking, by processing circuitry of the secure processing environment, the execution pipeline based on receipt of the sensor data, wherein invoking the execution pipeline includes providing the sensor data as input to the execution pipeline to produce an output from the execution pipeline;
matching the output against a set of acceptable outputs to determine that the output is acceptable; and
communicating the output, based on the output being acceptable, to an external processing environment.
